(19) United States
(12) Patent Application Publication
(10) Pub. No.: US 2001/0003286 A1
(43) Pub. Date: Jun. 14, 2001

(54) FLOOD CONTROL DEVICE

(76) Inventors: JAY E. PHILIPPBAR, SAN CLEMENTE, CA (US); GARY A. ISAACSON, JR., SAN DIEGO, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/353,193

(22) Filed: Jul. 14, 1999

(51) Int. Cl. G05D 7/06

(52) U.S. Cl. 137/624.12; 137/487.5

(57) ABSTRACT

A flood control device bases a valve closure decision on a plurality of sensed parameters. The parameters may be sensed by both a mechanical and an acoustic flow sensor. An adaptive parameter evaluation algorithm and fuzzy logic decision making may be used to reduce errors in triggering flow shut-off.

### BACKGROUND OF THE INVENTION

1. Field of the Invention

The present invention relates generally to a device which cuts off the water supply to a house or building in the event of overly high water consumption due to a leak, break or open faucet in the plumbing of a house or building.

2. Description of the Related Art

Other than a fire, perhaps the most catastrophic type of damage which can occur to a home or other building is damage due to water leakage from a broken or badly leaking water line. Since water supply lines may run throughout a house or other building, a leak may occur in the heart of the house or other building, and may result in extensive damage both to the structure and to the contents prior to the water supply being manually shut off.

The main causes of runaway water leakage are ruptured pipes, tubes or fittings; faulty washing machine hoses, water heaters, supply lines and other plumbing equipment; rusty or aging components, electrolysis, poor installation practices, poor quality materials, frozen pipes, tubes or hoses, earthquake activity and pressure surges. With so many different factors that can create plumbing failures and runaway water leaks, one can readily realize the need for a fluid shutoff safety device. Flooding in a home or other building brings water damage resulting in extensive destruction and expense. Massive difficulties ensue in the wake of interior structural flooding as families and businesses must contend with problems including substantial loss of time, money and the home, office or other building involved.

In the prior art, there exists a number of devices which are designed to control flow and to act as a shutoff in the event of a leak. These devices generally fall into two major categories, namely the shock operated type and the flow or pressure operated type. The shock operated device is designed to shut off flow in the event of a major shock such as that of an earthquake or the like. Examples of such devices are found in Lloyd, U.S. Pat. No. 3,747,616, and Mueller, U.S. Pat. No. 3,768,497 and Pasmany, U.S. Pat. No. 4,091,831. These devices are all designed for use with gas lines and do not address the problem of breaks or leaks in the line downstream of the devices. In addition, the shock operated type of control valves do not address the problem of broken or leaking water or gas lines due to normal erosion or the possibility that someone has simply opened a faucet or line and has forgotten to close it.

The second approach, which causes a shutoff of flow in the event of an overly large flow rate or an excess pressure change across the device, is illustrated, for example, by Frager, U.S. Pat. No. 2,659,383, Bandemortelli, U.S. Pat. No. 4,522,229, and Quenin, U.S. Pat. No. 4,665,932. All three of these devices are designed primarily for industrial applications and are large, complex and expensive and therefore, inappropriate for use in a home or other relatively small building. A simpler valve control device designed to cut off the water supply to a house or building is described in U.S. Pat. No. 4,880,030 entitled “Safety Flow Control Fluid Shutoff Device.” This device detects a downstream plumbing break or leak by sensing a water pressure increase within the valve. This increase in water pressure forces a piston to block the outlet of the device, thereby stopping flow through the device. It should be understood that the terms, “valve control device,” “control valves” and “flood control devices or valves” as used herein, are synonymous and interchangeable.

Control valves which detect a high rate of flow have many drawbacks. With these types of control valves, undesired shut-offs may occur because of a high rate of flow under normal service conditions due to increases of water or gas consumption during a given period or increases in population in a water main's area, for example. Furthermore, if a break occurs, a great amount of water might run away before the predetermined value of rate of flow has been reached to effectuate a valve shut-off. Control valves which are pressure sensitive are also not reliable because there are many factors that can cause a change in water pressure, which does not necessarily mean that there is an overflow of fluid. For example, in a system where water mains are connected together in any number and one of these mains breaks, the pressure head decreases swiftly not only on the broken main but also on all the other mains and the respective control valves which are connected to these mains may unnecessarily close at the same time. Also, if a pressure sensitive control valve is located in a high place and the upstream length of the main is great, the pressure differences due to gravitational forces can cause variations in the shut-off parameters, leading to possible shut-offs which are unnecessary and inconvenient to customers as well as to water supply companies.

The prior art valve control devices described above do not address the problem of a faucet which has inadvertently been left open. There is no way for these devices to distinguish this situation from everyday normal water use. Furthermore, these prior art valve control devices are unreliable in detecting gradual leaks that create gradual changes in pressure which may be undetectable by the device.

### SUMMARY OF THE INVENTION

The invention comprises methods and apparatus for controlling fluid flow. For example, the methods and apparatus of the invention may be advantageously applied to the control of a water supply of a residential structure. In one embodiment, the invention comprises a method of stopping fluid flow in the event of abnormal fluid flow conditions comprising evaluating a status of a plurality of system parameters; detecting abnormal fluid flow based at least in part on this status, and automatically stopping fluid flow in response to this detecting.

In another embodiment, a method of controlling the interruption of fluid flow to at least a portion of a plumbing system comprises defining one or more parameters indicative of system status, defining at least one parameter range upon which a decision to interrupt fluid flow is based, and automatically altering the range in response to a previously sensed value of the one or more parameters.

Multiple fluid flow sensors may be employed. In one embodiment, for example, a flood control device comprises a mechanical fluid flow sensor and an acoustic fluid flow sensor. Furthermore, the flood control device may comprise a control circuit coupled to the mechanical flow sensor and the acoustic flow sensor, wherein the control circuit has an output which depends at least in part on past or present signal inputs from the mechanical fluid flow sensor and the acoustic fluid flow sensor. Also provided is a shut-off mechanism receiving the control circuit output as an input so as to control fluid flow through the flood control device. In another embodiment, a mechanical fluid flow sensor is used to detect high fluid flow levels, and an acoustic transducer is used to sense low fluid flow levels.

### BRIEF DESCRIPTION OF THE DRAWINGS

The above and other aspects, features and advantages of the present inventions will be more apparent when presented in conjunction with the following drawings wherein:

FIG. 1 is a block diagram of a flood control device in one embodiment of the invention.

FIG. 2 is a block diagram of the sensing and control circuit in one embodiment of the invention.

FIG. 3A is an axial cross section of a measurement chamber incorporating capacitive impeller rotation sensing.

FIG. 3B is a graph of capacitance as a function of impeller position for the embodiment of FIG. 3A.

FIG. 3C is a schematic of a circuit that may be used to measure impeller position for the embodiment of FIG. 3A.

FIG. 4 is a block diagram of one embodiment of an acoustic flow sensing apparatus in accordance with one embodiment of the invention.

FIG. 5 is a flow chart illustrating a method of valve control utilized in one embodiment of the invention.

FIG. 6 is an elevational, cross-sectional, side view of an embodiment of a flood control device in one embodiment of the invention.

FIG. 7 is a cut-away perspective view of another embodiment of a flood control valve in accordance with the invention.

### DETAILED DESCRIPTION OF THE PREFERRED EMBODIMENT

The following description of the present invention is not to be taken in a limiting sense, but is made merely for the purpose of describing the general principles of the invention. The scope of the invention should be determined with reference to the claims.

It should be understood at the outset that although the flood control valve of the present invention will be described in the context of water flow in the water lines and plumbing of houses and buildings, the flood control device of the present invention may also be utilized to provide control valves in other areas such as gas lines or systems in which the flow of gas must be regulated. The principles of operation of the flood control valve of the present invention not only provide a means for preventing water damage due to broken, leaking or open water lines, but can also prevent, or at least lessen, the dangerous conditions which result from broken, leaking or open gas lines.

It is a primary function of a flood control valve to prevent water damage to a house or building in which a plumbing line, faucet, or other water source is broken, leaking or inadvertently left open. To this end, the flood control valve of the present invention operates on the principle of metering and measuring the volume of fluid delivered in a continuous steady flow. Such a flood control valve is extremely reliable because the measurement of the volume of a continuous flow is relatively easy and accurate when compared to measuring flow rate changes and pressure changes as in the prior art devices. It is easy to envision the utility that such a reliable flood control valve can provide, for example, in an earthquake situation when there may be many broken lines. By selectively shutting off certain water mains and/or lines, the flood control device of the present invention can close those mains and lines which are wasting water and causing flooding, while keeping open operational water mains and/or lines for use by firefighters or other emergency personnel. By closing off the broken mains and lines, the flood control valve of the present invention ensures that there will be adequate water pressure in the interconnected mains and lines for use by firefighters and other emergency personnel. Historically, inadequate water pressure resulting from broken water mains and lines has posed significant problems for firefighters in their battle against fires which typically arise in the aftermath of a serious earthquake. It should also be noted that the flood control valve of the present invention may be strategically located in the plumbing system of a house or building to shut-off only certain, specified lines. For example, by placing the flood control device downstream of a fire-sprinkler system, the flood control device will not be affected by the consumption of water by the sprinkler system in the event of a fire.

In addition to its primary function of preventing flooding in a house or building, the flood control valve of the present invention may also be used as a water conservation device. By shutting off the flow of fluid after a predetermined volume of fluid has been measured flowing through the device, the flood control device can effectively curtail the waste of water by broken or leaking pipes or by users who unnecessarily use excess amounts of water. It is readily apparent that such a flood control device would be of tremendous value in states such as California or Arizona, for example, where fresh water is scarce and its conservation is a major concern to their respective populations.

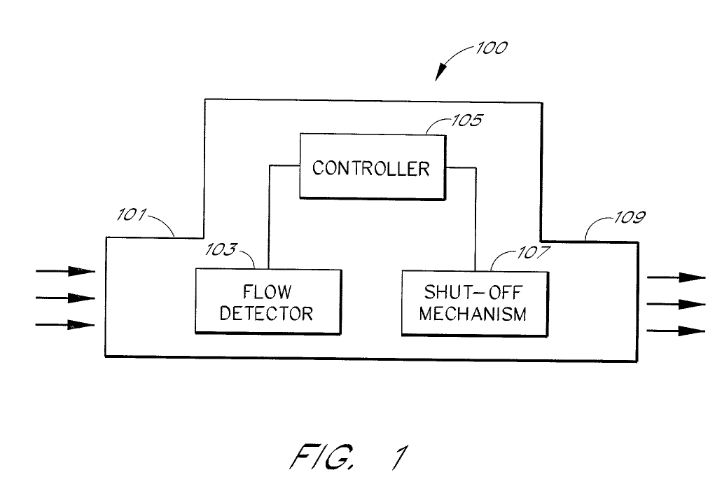

FIG. 1 shows a schematic diagram of a flood control valve 100 which includes an inlet 101 that may be connected to any incoming water source, such as a water main. The inlet 101 is typically of cylindrical design and of standard shape to mate with standard water lines for home or business use. Additionally, the inlet 100 may be either internally or externally threaded in order to meet the particular requirements of a given application. It is to be understood, however, that the shape, size and mating characteristics of the inlet 101 may be varied in order to achieve connectivity with any type of water supply line. Flood control device 100 further includes an outlet 109 which is connected to the plumbing system of a house or building. Similar to the inlet 101, the outlet 109 may have any shape, size and mating characteristics in order to achieve connectivity with any type of plumbing line, pipe or faucet of a house or building.

Between inlet 101 and outlet 109, and within a housing 111, the flood control valve 100 further includes a flow detector 103, a controller 105 and a shut-off mechanism 107. The flow detector 103 serves the function of measuring aspects of fluid flow through the flood control valve 100. The controller 105, in response to these measured flow conditions, stops fluid flow through the device if it is determined that the measured conditions indicate a plumbing system fault and consequent flooding.

It will be appreciated that defining an appropriate decision making process is of fundamental importance in the design of these types of flood control devices. As initially described above, several approaches have been developed. In some devices, fluid flow is shut down if it continues beyond a pre-selected time period. In others, flow rates which are greater than a specified limit are shut down. In another advantageous embodiment, the device takes advantage of the fact that in many plumbing systems, such as residential housing, the flow of water into the structure will periodically come essentially to a stop when no sinks, toilets, showers, etc. are being used, as long as no leak is present. In some flood control device embodiments, therefore, the flow detector tracks the volume, or quantity, of fluid which has continuously passed into the plumbing system since the last “no-flow” condition. When this scheme is applied to the embodiment illustrated in FIG. 1, when a preset volume of fluid has been detected by flow detector 103 since the last zer-flow condition, the controller 105 will activate the shut-off mechanism 107 which then shuts off either the inlet 101 or the outlet 109, thereby stopping any further flow of fluid through flood control valve 100. A variety of embodiments of this nature are described in U.S. Pat. No. 5,782,263 to Isaacson, and pending U.S. patent application Ser. No. 09/036,992, filed Mar. 9, 1998 and entitled Flood Control Device, now U.S. Pat. No. ______. The disclosures of U.S. Pat. No. 5,782,263 and pending application Ser. No. 09/036,992 (now, U.S. Pat. No. _______) are incorporated by reference herein in their entireties. This embodiment can be advantageous in that both high flow pipe or hose ruptures and slow pinhole type leaking may be detected and the flow shut-down before an excessive amount of water has flooded the premises.

In other advantageous flood control devices, embodiments of which are described in more detail with reference to the following Figures, the flow detector 103 simultaneously tracks a plurality of system parameters. These system parameters may include flow characteristics such as the total continuous flow volume since the last “no-flow” condition as in the above embodiment. They may further include a measurement of the instantaneous flow rate, a detection of regular, periodic flows, as well as other system parameters such as time of day. By analyzing all of these characteristics, a decision is made by the controller 105 whether or not a plumbing fault has occurred. If such an abnormal situation is detected, the controller 105 shuts off either the inlet 101 or the outlet 109.

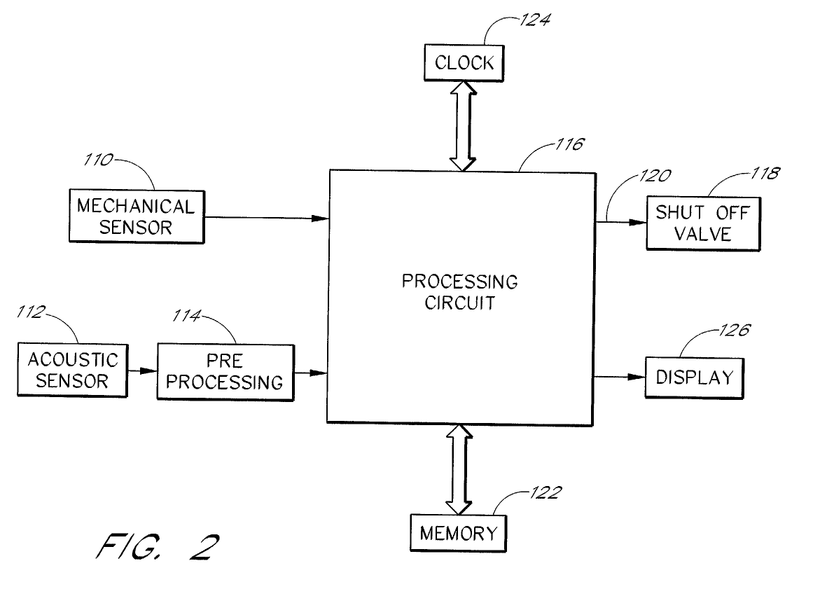

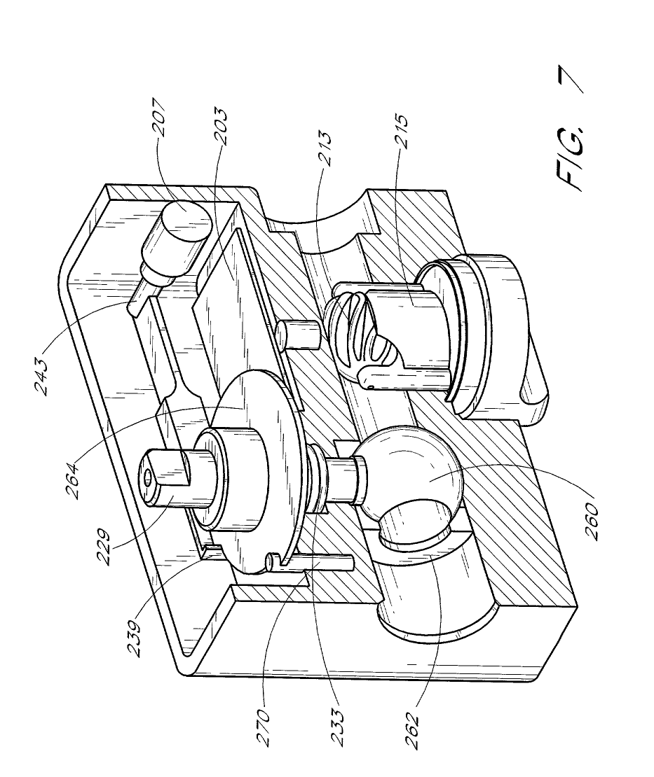

A detection circuit which may be utilized to perform such multi-parameter valve control is illustrated in FIG. 2. The circuit of FIG. 2 includes two separate forms of flow detection. First, a mechanical flow sensor 110 is included to measure flow rates through the valve. In some advantageous embodiments, the mechanical flow sensor 110 is a turbine style flow meter comprising a rotating impeller which turns at a rate which is dependent on the flow rate of fluid through the valve. The design of various types of impellers which are suitable for use in the invention are well known in the art. As described in further detail below in connection with FIGS. 6-7, the impeller is advantageously of an axial helical design. As an alternative to the turbine type mechanical sensor 110, a positive displacement flow meter may be utilized. In a positive displacement flow meter, a partition plate between inlet and outlet ports forces fluid to flow around a cylindrical measuring chamber, thereby displacing an oscillating piston inside the measuring chamber. The position of the piston may be sensed magnetically from outside the chamber.

The type of mechanical flow sensor which is most desirable will depend on cost, dynamic range, minimum detectable flow, and reliability, for example, and may be different depending on the nature of the plumbing system the device is to be installed on. In general, commercially available positive displacement type flow meters have a larger dynamic range than commercially available turbine style flow meters. Suitable flow meters which can accurately measure from about ½gallon per minute to about 30-50 gallons per minute are commercially available. The general design and use of these various types of flow meters is well known in the art.

Some of the limitations inherent in the mechanical flow sensor 110 may be overcome by supplementing this measurement device with other flow detection mechanisms which are more suited to low flow conditions, or which otherwise enhance the system's capacity to characterize flow conditions as normal or abnormal. For instance, pressure drop sensing may be used to detect very low flow conditions as is described in U.S. Pat. No. 5,007,453 to Berkowitz et al., the disclosure of which is hereby incorporated by reference in its entirety.

In some embodiments, flow sensing and characterization is enhanced by additionally providing an acoustic flow sensor 112. The acoustic flow sensor may comprise a piezoelectric transducer as is well known in the art. The transducer may be affixed to the valve itself, or on a pipe in another location of the plumbing system. In some systems, several acoustic flow sensors 112 could be provided at different locations in the plumbing system being monitored to obtain more localized and detailed information regarding flow conditions.

The acoustic flow sensor has an electrical output which varies in frequency content and amplitude depending on many different factors. The output of the acoustic flow sensor may thus contain information concerning not only the flow rate, but also possibly the source or nature of the flow, as the output amplitude at various frequencies may change depending on the flow outlet point such as a shower head, toilet, or a fault condition such as a broken washing machine hose or slow foundation leak. To detect these changes in acoustic output from the transducer, the signal is routed to pre-processing circuitry 114 which includes, for example, filtering and amplification. Aspects of some advantageous acoustic signal analysis are described in additional detail below with reference to FIG. 4.

Both the mechanical flow sensor 110 and the acoustic flow sensor are coupled to a processing circuit 116 which will typically include a microprocessor or microcontroller. A wide variety of suitable devices are commercially available from Texas Instruments, Motorola, Intel, and others. The model AT9OS8515 microcontroller from Atmel Corp., for example, may be used in some embodiments. The processing circuit 116 is in turn coupled to a shut-off valve 118. The processing circuit 116 receives the data from the mechanical sensor 110 and acoustic sensor 112, and processes and/or analyzes the data to determine whether or not the fluid flow through the flood control device should be shut down. Thus, if the processing circuit 116 determines that a fault condition is present in the plumbing system, an output signal 120 is asserted which closes the shut-off valve to stop further fluid flow.

Data received from the mechanical sensor 110 and the acoustic sensor 112 may be stored in a memory 122 as it is collected. Also stored in the memory 122 may be historical information regarding past fluid flow conditions, total flow over a selected time period, programmed set-points for actuating the shut-off valve 118, as well as other information for system operation. A clock or timer circuit 124 is also preferably provided which tracks the current time of day. In addition, the system advantageously includes a display 126, which may indicate to the user the current system conditions, currently programmed set-points, or other information useful to the user of the flood control device.

The system illustrated in FIG. 2 provides superior flexibility and accuracy in operation over existing flood control valves. The acoustic sensor 112, mechanical sensor 110, and system clock 124 provide several different types of information to the processing circuit 116 so that the processing circuit 116 may make a decision concerning valve shut-off based on a more sophisticated analysis of the plumbing system than has been previously available. This dramatically reduces the occurrence of false positive flooding determinations, where the fluid flow is shut-off during normal use, as well as false negative flooding determinations, where fluid flow is not shut off during a fault condition.

With a flood control device incorporating these aspects of the invention, several different criteria may be used to make flow on/off decisions. For example, the current instantaneous flow rate may be monitored regularly at short intervals. From this measurement, zero-flow conditions may be detected, and from the measured instantaneous flow rate and the time between measurements, the integrated total flow amount since the last zero-flow condition may be computed. Using both of these parameters, the system may shut down fluid flow if either the instantaneous flow rate or the integrated total flow amount are above programmed thresholds for these variables.

Furthermore, using the clock 124, these two programmed thresholds may be made time dependent. For example, the thresholds may be increased during the day, or when automatic outdoor landscape watering is occurring, and decreased at night, when flow is expected to be much lower.

Data from the acoustic sensor 112 may be used to further supplement this decision making process. In one embodiment, the mechanical sensor 110 is used to detect and measure high flow rate conditions, and the acoustic sensor 112 is used to detect low-flow conditions. This can be useful because detection of very low flow rates is often difficult with a mechanical flow sensor such as an impeller. Using the acoustic sensor 112 for detection and characterization of low flow rates simplifies the design of the mechanical sensor 110 considerably. In this embodiment, low flow rate leaks can be detected by their acoustic signal even if the flow rate of the leak is not high enough to be detected by the mechanical sensor 110.

The acoustic sensor 112 may also be used to supplement the decision making process for high flow conditions as well. For instance, the setpoint for maximum allowed total flow since the last zero-flow condition may be reduced if the acoustic signal being received by the processing circuit 116 during a flow event has an energy in a particular frequency band that is not generally associated with the plumbing system during normal conditions.

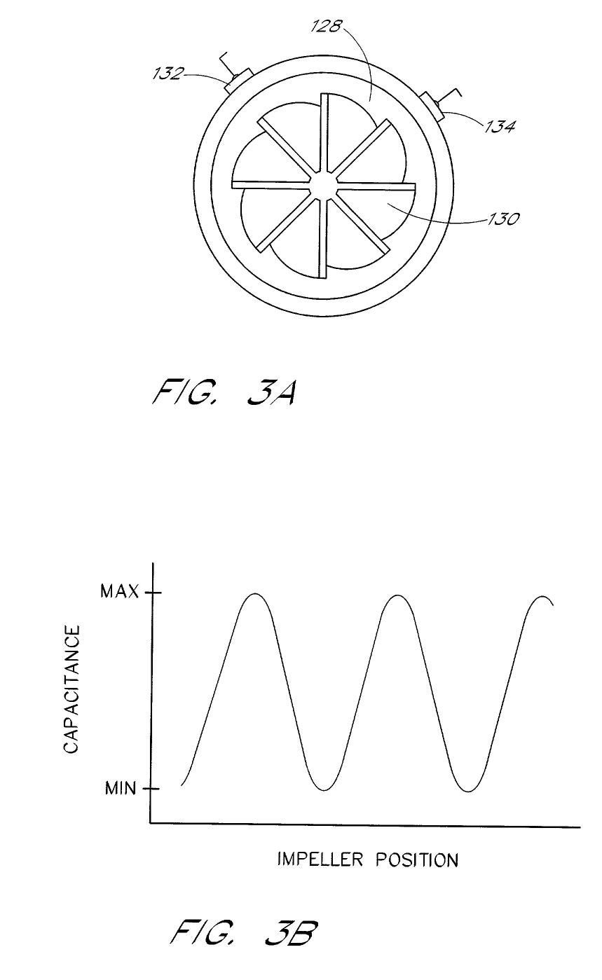

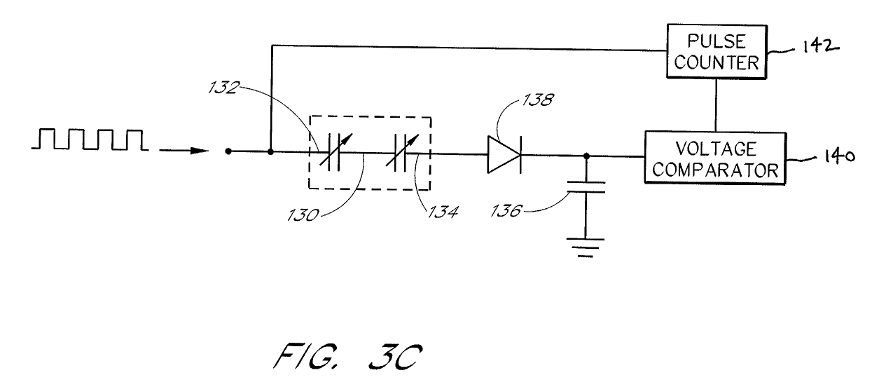

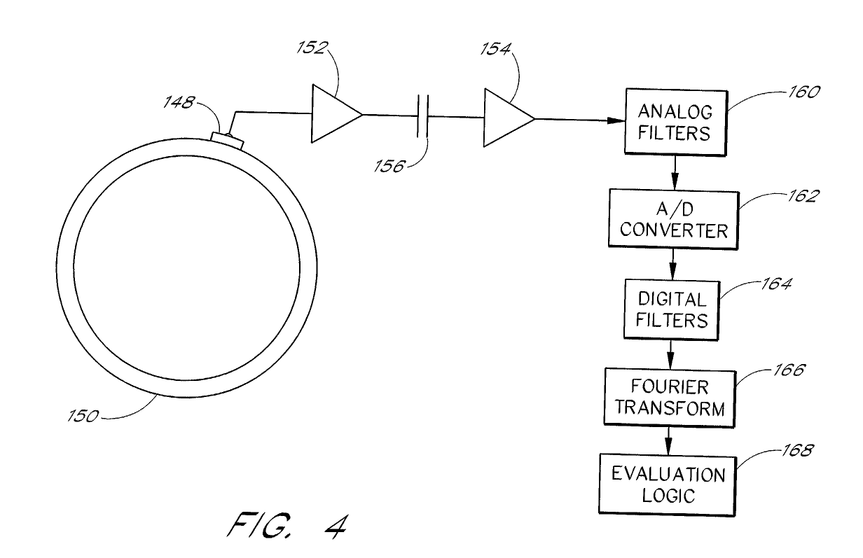

As mentioned above, several different types of mechanical flow sensor 110 may be utilized with the present invention. To detect low flow conditions, it is important to minimize the mass of any moving element in the flow stream. In addition, it is important to minimize the cost of the apparatus needed to measure flow with the mechanical sensor 110. In many commercially available mechanical flow meters, movement or rotation of a mechanical element is sensed magnetically. This requires relatively expensive sensors as well as moving magnets or magnetizable materials, which can add cost and mass to the moving element. This can be avoided with the movement detection apparatus and method illustrated in FIGS. 3A-3C.

Referring now to FIG. 3A, a cross section of a measuring chamber 128 with an axial impeller 130 mounted inside is shown. A first electrode 132 is plated, adhesively attached or otherwise affixed to the outside of the wall of the chamber 128. A second electrode 134 is similarly affixed. To detect impeller 130 rotation, the capacitance between these two electrodes 132, 134 is monitored. It will be appreciated that if the impeller 130 is metal or metal plated, the capacitance between these two electrodes 132, 134 will be higher when the vanes of the impeller 130 are aligned with the electrodes, as illustrated in FIG. 3A. Therefore, as the impeller rotates, the capacitance present between the first electrode 132 and the second electrode 134 will oscillate between a high and low value at a frequency which increases as the speed of the impeller increases. This is illustrated in the graph of FIG. 3B. It will be appreciated that if desired, the electrode placement outside the chamber 128 and the metallization of the impeller may be configured such that the capacitance value measured between the electrodes uniquely determines the position of the impeller inside the chamber.

This capacitance variation may be detected in a wide variety of ways. An analog measurement may be used as the AC impedance between the electrodes 132, 134 will also oscillate between a maximum and a minimum value. An AC potential at a frequency much higher than the impeller rotation rate may be applied and the induced current measured as an indicator of capacitance and thus impeller position. The varying high frequency current induced by the applied potential may be sensed and demodulated to produce a signal indicative of the capacitance.

The same basic principle may be utilized with the digital circuit of FIG. 3C. With this circuit, a unipolar pulse train is applied to the first electrode 132, and the second electrode is coupled to a charge storage capacitor 136 through a diode 138. The voltage across the storage capacitor 136 is monitored with a voltage comparator circuit 140, and the number of pulses applied to the first electrode 132 is tracked by a pulse counting circuit 142.

In operation, the storage capacitor is first discharged. Pulses are applied to the first electrode 132, and are counted until the voltage across the storage capacitor 136 reaches a specified level as sensed by the voltage comparator 140. The counter thus produces a pulse count which is stored by the system. If the capacitance between electrodes 132 and 134 is high, the number of pulses required to charge the capacitor 136 to the selected level will be relatively low and the stored pulse count will be small. In contrast, if the capacitance between electrodes 132 and 134 is low, the number of pulses required to charge the capacitor 136 to the selected level will be relatively large and the stored pulse count will also be large. The pulse count will therefore oscillate between a maximum and a minimum value as the impeller rotates. The frequency of these oscillations is a measure of impeller rotation rate. A series of pulse counts can be routed to the processing circuit 116 of FIG. 2 for analysis. If pulse count measurements are made at a rate of at least twice the maximum expected oscillation frequency of the capacitance between the electrodes 132, 134, well known digital signal analysis techniques may be used to extract any desired signal parameter of interest, including frequency of capacitance oscillation, and thus impeller rotation rate. Thus, impeller rotation and associated fluid flow rate may be measured without the expense and weight inherent in magnetic detection schemes.

A block diagram of a suitable acoustic signal analysis circuit is shown in FIG. 4. As shown in this Figure, an acoustic transducer 148 is coupled to a portion of the plumbing system 150, either at the flood control device or at another location. The output of the transducer 148, which will typically comprise an approximately 1 to 50 mV peak-peak electrical signal is routed to a first amplifier 152 having an output which is AC coupled to a second amplifier 154 through a capacitor 156. This amplification stage may amplify the raw signal by a factor of 100-1000 for example, depending on the transducer design and desired maximum output signal level.

As mentioned above, the output signal includes components at a wide variety of frequencies within the frequency range of about 100 to 10,000 Hz. In some installations, it has been found that signal amplitude in the 4-5 kHz range is relatively strongly dependent on the fluid flow rate through the flood control device. Signal energy in this band can therefore be used to detect low flow rates which may not be detectable by the mechanical flow sensor 110. Signal energy in other frequency bands may be correlated to the operation of specific water utilization fixtures such as a shower or a dishwasher attached to the plumbing system. Advantageously, analog filters 160 may be used to reject signal energy in frequency ranges outside of the bands that contain significant information concerning plumbing system status and performance. The analog filters 160 may also include low-pass anti-aliasing filters prior to digitization of the signal with an analog to digital converter 162.

The signal may be further filtered with digital filters 164, and the digitized signal may be analyzed in the frequency domain after Fourier transformation 166. Signal characterization logic 168 may then be utilized to compare the signal to characteristics of known normal or abnormal plumbing system conditions. It will be appreciated that the digital filters 164, Fourier transformation 166, and characterization logic 168 may advantageously be implemented in software running on a microprocessor or microcontroller provided as part of the processing circuit 116 of FIG. 2.

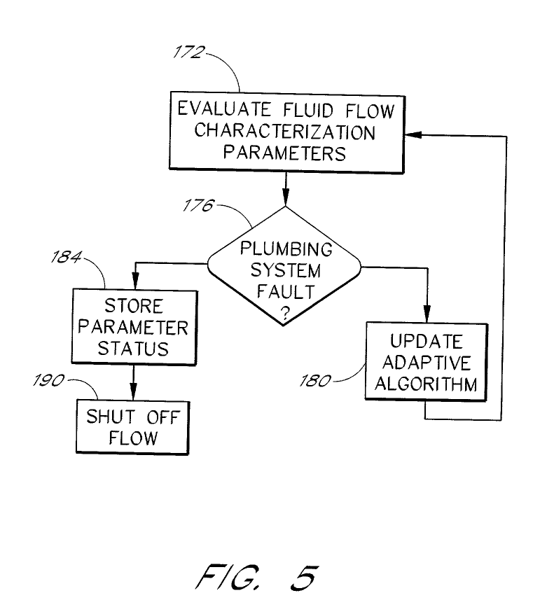

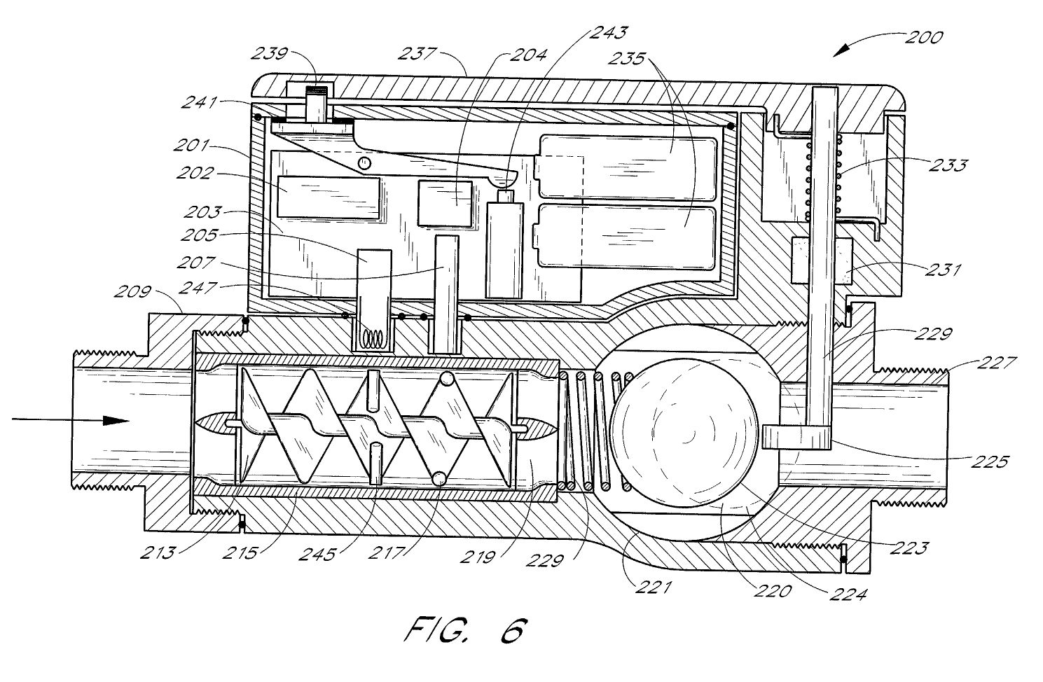

FIG. 5 shows a method of flow analysis which may be used in flood control devices according to some embodiments of the invention. At a first block 172, the system evaluates at least one, and preferably a plurality of fluid flow characterization parameters. In most embodiments, this evaluation comprises comparing existing system conditions with model system conditions. Deviations between existing conditions and model conditions are detected. Based on the presence or absence of significant deviations, a decision is made at decision point 176 whether or not a plumbing fault exists.

Of course, to avoid false positive and negative fault detection, this process of evaluation should be as accurate as possible, and it is therefore advantageous to consider a large number of system parameters to make a shut off decision. With the system illustrated in FIG. 2, system condition data points may be periodically collected, once per minute, or even once per second, for example. These data points may include current flow rate and acoustic signal energy in certain desired frequency bands. The time of day, and if desired, also the date, will advantageously also be stored in association with this data. This information would comprise the current instantaneous system flow condition. This data may be used directly to make a decision about valve shut-off. For example, if the instantaneous flow rate is determined by the system to be excessive (as compared to a stored set-point for example), the valve may be shut-down immediately. In addition, by storing and processing a series of these data points, a wide variety of useful historical flow information may be produced and utilized by the system in the decision making process.

For example, zero-flow conditions may be detected, and integrated total flow through the valve since the last zero-flow condition may be calculated by multiplying the measured flow rate by the data sampling interval, and adding the result to the existing stored integrated flow volume value. This may continue until a zero-flow condition is again reached, at which point the stored integrated flow value is reset to zero. Excessive integrated flow may thus also be used to detect plumbing system faults.

A series of flow rate measurements may also be Fourier transformed into the frequency domain for analysis. Normal water usage will tend to be periodic on a several minute time scale during the day. In contrast, leaks and faults tend to produce a constant flow which will continue for a much longer period if unchecked. Therefore, an increase in continuous flow appearing in the flow frequency spectrum without a corresponding increase in periodic flow can be used as an indication of some types of faults. This type of analysis may also be useful to identify and compensate for certain common plumbing problems such as a toilet leak. This will produce an identifiable periodic flow essentially 24 hours a day, but likely does not require a plumbing system shut-off.

It can also be useful to the decision making process to calculate and retain statistical information concerning past flow events. For instance, histograms of measured instantaneous flow rates and measured total flow volumes since the preceeding zero-flow condition may be stored to allow a characterization of the distribution of these measured parameters around their median values. By generating and storing these histograms, current system condition can be characterized within the context of past system behavior. In contrast to a comparison with fixed and pre-selected setpoints, this allows the system to quantify, in terms of deviation from the median, for example, how normal or abnormal the current system condition is. With this information, “more” abnormal system conditions may trigger valve shut-off sooner than “less” abnormal system conditions.

In some embodiments, an adaptive algorithm is used in evaluating the data. With an adaptive algorithm, the setpoints or other stored parameters against which current conditions are compared can be continually updated over time while the flood control device is installed. As described above, for example, histograms of past behavior may be continually updated. Decisions which are based on deviation from the median of a histogram, therefore, will depend on the content of the continually altered histogram. Various adaptive programs and programming techniques to accomplish this type of updating are well known in the art, and may be utilized in conjunction with the present invention.

Furthermore, a fuzzy logic decision making process may advantageously be used to decide whether or not to shut off the valve. Many fuzzy logic decision making techniques are well known in the art and may be implemented advantageously in the present context. In contrast to standard decision making, where, for example, a setpoint is either exceeded or not exceeded, fuzzy logic decision making involves weighting the various parameters used in the decision making process, and calculating a value from the weighted parameters which is interpreted as lying somewhere between 100% “yes” and 100% “no”. This value is then de-fuzzified using one of several known methods to produce the decision of whether or not the flow through the flood control device should be shut down or not. Such techniques are useful in situations where a variety of factors may be important to a decision in different and/or interrelated ways. These techniques may thus be advantageously utilized with a flood control system in accordance with the invention.

Returning now to FIG. 5, if the system decides that no plumbing fault is indicated, at block 180 the system updates the adaptive algorithm, and loops back to block 172 to evaluate the next system condition data point. If, however, a decision is made that a plumbing system fault exists, the system will preferably store the system parameters which led to this decision at block 184, and shut off flow through the flood control device at block 190.

FIGS. 6 and 7 focus on advantageous mechanical apparatus which may be used to close a shut-off valve following the shut-off decision. Referring now to FIG. 6, a flood control device 200 which operates in accordance with one embodiment of the present invention is shown. In this embodiment, an axial impeller 213 is used to implement the mechanical flow sensor 110 and a predetermined number of revolutions of the axial impeller 213 represents a gallon of fluid. Flow of fluid through the flood control valve 200 causes the helical axial impeller 213 to turn, preferably even at very low flow rates. The impeller is of very low mass and mounted on either end on small, low resistance bearings 219 which are housed in axial impeller cartridge 215. In the preferred embodiment, axial impeller cartridge is removable so that it may be cleaned or replaced as necessary to ensure proper operation of the flood control valve 200. The material used to construct the impeller 213 should displace the same weight as the fluid being transferred. When this is achieved, the friction within the bearings is reduced since the impeller is neither floating nor sinking, either of which would place a radial load on the impeller bearings 219. In the preferred embodiment, helical axial impeller 213 may be made from a suitable plastic or nylon material having a mass which achieves neutral radial loading when immersed in water.

In a conventional flow rate sensing design illustrated in this Figure, the impeller 213 has, located on one or several of its vanes, one or more indicator masses 217, preferably of a metal or magnetic material, which can be detected as they pass a proximity sensing device 205, as the impeller is turned by the flow of fluid. The proximity sensing device 205 can be a magnetic reed switch, a “hall effect,” eddy current, or optical detector, all of which are well-known in the art. Use of this type of proximity device allows the detection of fluid flow without penetrating the pressure vessel of the fluid line with shafts, wires, or other devices that move, require seals, and represent potential leaks. Resistance on the impeller is minimal or nonexistent, allowing detection at very low flow rates. Alternatively, of course, impeller rotation may be sensed using the variable capacitance technique described in detail with reference to FIGS. 3A through 3C.

The electronics which implements the decision making process described above is mounted on a printed circuit board 203 in the device housing. The printed circuit board may mount the electronic components described above with reference to FIG. 2, including memory 202, and a microprocessor or microcontroller 204. As described above, an acoustic sensor 247 may be placed in proximity to the fluid flow in the flood control device 200. When the processor 204 makes a decision to close the valve, a solenoid 207 is activated, which in turn activates a trigger 239. The activation of trigger 239 closes outlet 227 to stop all flow of the fluid through the flood control device 200 as will be explained in more detail below. The flood control device 200 remains closed until it is manually re-opened by re-cocking a cocking lever 237, which functions as a release mechanism. The functioning of the cocking lever 237 will be described in further detail below.

When current is applied to solenoid 207, the plunger 243 is forced upward thereby activating a trigger mechanism 239 which holds the cocking lever 237 in place. The solenoid 207 and corresponding plunger 243 operate under the well-known principles of electromagnetic induction and such devices are well-known in the art and commercially available. When the trigger 239 releases the cocking lever 237, the cocking lever 237 rotates axially about cam shaft 229 which is attached to the cocking lever 237, which in turn rotates a cam 225. The cocking lever 237 is rotated by means of a drive spring 233 which is held in a coiled position when the cocking lever 237 is in the cocked position. Upon release of the cocking lever 237 by the trigger mechanism 239, the drive spring 233 uncoils thereby rotating the cocking lever 237, the cam shaft 229 and the cam 225. At this point, the cam 225 is in the closed position.

The shut off mechanism can be either a gate valve, a rotating ball valve, or a ball check valve. In the embodiment of FIG. 6, the shut off mechanism is the ball check valve. This valve consists of a ball 223 placed in a ball chamber 220 which is in the flowpath of the fluid. The cam 225 controlled by shaft 229 and cocking lever 237 holds the ball 223 out of a seat 224. The seat 224 and cam 225 are downstream from the ball 223. When the cam 225 is rotated to the position which releases the ball 223, the ball 223 moves into the seat 224, shutting off all fluid flow through the flood control valve. A ball spring 218 can be used to ensure seating of the ball 223 at very low flow rates. This allows shutting down of fluid flow even from a pinhole leak.

The outlet 227 remains in the closed position until the cocking lever 237 is manually placed in the cocked position and fluid flow is restored. As the cocking lever 237 is moved to the cocked position, the cam 225 pushes the ball 223 out of its seat 224 to the open position. Longitudinal movement of the ball 223 in and out of the seat 224 is guaranteed by three ball guide ribs 221, equally placed around the ball chamber 220. Spring loading of the cocking lever 237 causes it to move to the closed position when it is released by triggering mechanism 239. Packing seal 231, or otherwise known as stem packing, is preferably used around the cam shaft, since it penetrates the liquid pressure chamber. Packing seal 231 ensures a water-tight seal so that leaks in the flood control valve 200 are prevented.

The power to drive the electronic circuitry 203 and the solenoid 207 may be provided by solar cell charged batteries; a power supply transformer plugged into a wall outlet in which the power supply drives the circuit board and keeps a backup battery charged; or a long-life battery pack 235, preferably of the lithium type, that drives the circuit for three to five years, or more, and if available, with a low battery aural warning. The long life battery pack 235 with a low power drain electronic circuit is the preferred power source.

FIG. 7 illustrates a second flood control device embodiment which is constructed using many of the same fundamental mechanical principles of the embodiment shown in FIGS. 6 but which uses a rotating ball valve instead of a ball check valve. Located within a fluid flow channel through the housing of the device is a flow sensing impeller 213, which is advantageously mounted on a removable cartridge 215. In contrast to the embodiment of FIG. 6, however, the cartridge 215 of FIG. 7 is removable from the side of the housing rather than the end. This can result in more convenient maintenance as the device need not necessarily be disconnected from the plumbing system to remove and replace the impeller cartridge 215 when needed. Between the impeller 213 and the fluid flow outlet is a rotating ball valve 260 which abuts a seal 262. The ball 260 and seal 262 are preferably made from a material such as teflon which resists sticking and deposition of insoluble salts or other particulate material which can interfere with ball valve rotation.

The ball valve 260 is attached to a shaft 229 which is biased toward counterclockwise rotation by a drive spring 233. In the position illustrated in FIG. 7, the drive spring 233 is under tension, and the shaft 229 is held in place by a trigger 239 which latches the edge of a notch in a wheel 264 fixed to the shaft 229.

Control electronics which are mounted to a printed circuit board 203 in the housing of the device selectively activate a solenoid 207 using the decision making principles described in detail above. Activation of the solenoid 207 moves a plunger 243 to activate the trigger 239. When the trigger 239 is activated, the wheel 264 is released, freeing the shaft 229 to move in the counter clockwise direction under the influence of the drive spring 233 until the edge of the notch engages a pin 270. In this orientation, the ball valve 260 is closed, and flow through the device is stopped.

While the above detailed description has shown, described, and pointed out fundamental novel features of the invention as applied to various embodiments, it will be understood that various omissions and substitutions and changes in the form and details of the system illustrated may be made by those skilled in the art, without departing from the intent of the invention. The scope of the invention is indicated by the appended claims rather than by the foregoing description. All changes which come within the meaning and range of equivalency of the claims are to be embraced within their scope.

What is claimed is:

1. A flood control device comprising:
a mechanical fluid flow sensor;
an acoustic fluid flow sensor;
a control circuit coupled to said mechanical fluid flow sensor and said acoustic flow sensor, said control circuit having an output which depends at least in part on past or present signal inputs from said mechanical fluid flow sensor and said acoustic fluid flow sensor; and
a shut-off mechanism receiving said control circuit output as an input so as to control fluid flow through said flood control device.

2. The flood control device of claim 1, wherein said acoustic fluid flow sensor comprises a band pass filter circuit.

3. The flood control device of claim 1, wherein said mechanical flow sensor comprises a helical axial impeller.

4. The flood control device of claim 1, additionally comprising a clock.

5. The flood control device of claim 1, wherein said mechanical fluid flow sensor and said acoustic fluid flow sensors have outputs routed to a processing circuit.

6. The flood control device of claim 5, wherein said processing circuit is configured to analyze said output signals using fuzzy logic decision making so as to produce said control circuit output and to control fluid flow through said flood control device.

7. In a fluid supply system, a method of stopping fluid flow in the event of abnormal fluid flow conditions comprising:
evaluating a status of a plurality of system parameters;
detecting abnormal fluid flow based at least in part on said status;
automatically stopping fluid flow in response to said detecting.

8. The method of claim 7, wherein said system parameters are selected from the group consisting of instantaneous flow rate, total integrated flow volume over a selected period, and time of day.

9. The method of claim 7, wherein said detecting comprises analyzing said parameters using a fuzzy logic algorithm.

10. In a flood control device configured to shut-off fluid flow in the event of a break, leak, or other malfunction in an associated plumbing system, a method of sensing fluid flow comprising:
sensing high fluid flow levels with a mechanical fluid flow sensor; and
sensing low fluid flow levels with an acoustic transducer.

11. The method of claim 10, additionally comprising filtering an output signal of said acoustic transducer with a band pass filter.

12. The method of claim 10, additionally comprising detecting substantially zero-flow conditions with said acoustic transducer.

13. A method of controlling the interruption of fluid flow to at least a portion of a plumbing system comprising:
defining one or more parameters indicative of system status;
defining at least one parameter range upon which a decision to interrupt fluid flow is based; and
automatically altering said range in response to a previously sensed value of said one or more parameters.

14. The method of claim 13, wherein said at least one parameter range is dependent upon a sensed value of a different parameter.

15. The method of claim 13, wherein said at least one parameter range is dependent on the time of day.

16. A method of controlling water supply to a portion of a plumbing system of a residential structure, said method comprising:
defining a plurality of parameters indicative of system status;
defining a plurality of parameter ranges upon which a decision to interrupt said water supply is based; and
automatically altering at least one of said plurality of parameter ranges in response to a previously sensed value of at least one of said plurality of parameters.

17. A flood control device comprising:
means for evaluating a status of a plurality of system parameters;
means for detecting abnormal fluid flow based at least in part on said status;
a valve positioned to interrupt said fluid flow and connected to said means for detecting abnormal fluid flow so as to be forced closed when abnormal fluid flow is detected.

18. The flood control device of claim 17, wherein said means for detecting abnormal fluid flow comprises a processing circuit configured to adapt decision making to past status of said plurality of system parameters.
